(19) United States
(12) Patent Application Publication
(10) Pub. No.: US 2020/0273362 A1
(43) Pub. Date: Aug. 27, 2020

(54) AUTOMATED SPORTS TRAINING WORKFLOW, DELIVERY AND TRACKING SYSTEM

(71) Applicant: Alan Discount, Fontana, CA (US)

(72) Inventor: Alan Discount, Fontana, CA (US)

(21) Appl. No.: 16/854,690

(22) Filed: Apr. 21, 2020

Related U.S. Application Data
(63) Continuation of application No. 15/901,835, filed on Feb. 21, 2018.
Application No. 15/901,835 is a continuation of application No. 14/616,685, filed on Feb. 7, 2015, now abandoned.

(51) Int. Cl. G09B 5/12; G09B 5/14; G09B 5/06; G09B 19/00

(52) U.S. Cl. CPC G09B 5/125; G09B 5/14; H04L 67/12; G09B 19/0038; G09B 5/06

(57) ABSTRACT

An automated workflow system for implementing, monitoring, tracking and guiding Athlete training is disclosed. The system is comprised of a series of proprietary software applications, technology platform and content, accessible using any device that is connected to the Internet and utilizes a web browser. The system, which can be used independently or through the guidance of a Coach, directs and manages all aspects of Athlete training workflow and activity including games, practices, lessons, workout sessions, et cetera, which historically have not been viewed in a holistic manner. As the Athlete participates in each activity their results are recorded in the system, displayed for viewing, and compared to benchmarks of similar Athletes. The system then guides the focus and attention of future training activities to concentrate on development areas that address and fill in gaps in the Athlete's abilities thereby enhancing and accelerating subsequent performance.

### CROSS-REFERENCE TO RELATED APPLICATION

This application is a continuation of U.S. patent application Ser. No. 15/901,835, filed Feb. 21, 2018 by Alan Discount and titled “Automated sports training workflow, delivery and tracking system,” which is a continuation of U.S. patent application Ser. No. 14/616,685, filed Feb. 7, 2015 by Alan Discount and titled “Automated sports training workflow, delivery and tracking system” (now abandoned), each of which is incorporated by reference herein in its entirety.

### BACKGROUND OF THE INVENTION

United Sports' training generally involves the teaching and practicing of a variety of skills or competencies deemed important to mastering a sport, most often explained through the use of verbal communications. These competencies can be both very broad and very deep in most major sports; for example, they can be either general in nature (i.e. building an Athlete's overall strength, agility or speed), very specific to an activity or task (i.e. working on individual skills such as throwing, shooting, kicking, pitching, hitting, running, catching) or related to understanding the unique rules or strategy of the sport. Due to the complexity inherent in many team sports, it can often take long periods of time to fully understand, let alone master the skills necessary for the Athlete to have success. To make matters even more challenging, in team sports the ratio of players to coaches is very high, and in many cases, especially at beginner levels, Coaches are unpaid volunteers with limited background and experience. As a result, each player receives only limited training attention, and that attention is often cursory at best. In fact, most coaches will tell you they tend to coach to the lowest common denominator of their players, or those that demand the most attention to be functional in the sport so as to not hurt the team's chances of competing. By default, the players with talent tend to get the least attention and effort focused on their individual personal development.

Athletes with a higher level of commitment that take the time to get more meaningful training from experienced Coaches outside of the group or team environment tend to develop these core skills at a more rapid pace. When working one-on-one with a trained Coach, Athletes receive individualized critique of their skills, and personalized instruction, based on the Coach's experience, about how to fix problems, replicate proper technique, learn specific tasks, or address deficiencies. While this approach can result in a dramatic improvement in skills and abilities, it is still lacking from a variety of perspectives:

1) Most Coaches communicate by using predominantly verbal communications and to a much lesser extent, physical demonstration of the skill being taught. Often coaches will simply call out instruction to Athletes to correct things like position, movement or mechanics, and then through repetitive action and continued verbal reinforcement, if the Athlete follows directions, behavior is hopefully changed for the better. Despite the fact that we live in an age where digital media and data manipulation is prolific, very little use of video and electronic analysis is used in this type of training, especially when players are younger and would benefit the most. And because much of this happens on the fly, sadly in many cases, key data crucial to monitoring the Athlete's development isn't even tracked at all.

2) If information to monitor development is recorded, the type of information that has been historically tracked does not necessarily reflect the Athlete's true performance. For example, it does not take into consideration other factors that may or may not influence performance such as competition, playing conditions, or other pros and cons or intangibles not captured by conventional statistics and data, Additionally, it is extremely rare to have any data that is captured reside in a single comprehensive system. It typically exists in a variety of places such as scorecards or scorebooks, hand written stat sheets, coach's notebook, etc. And any time an experienced Coach spends writing and analyzing data, although valuable to player development, is not time spent actually doing what they love best—coaching.

3) Even if data is captured in game situations, all other activity outside of game situations, such as practices, lessons, workout sessions, etc. rarely gets tracked and included in evaluated performance. This can lead to an incomplete picture of the Athlete's abilities and development, as well as put the Athlete at risk of being overworked, or subject to unhealthy conditions thereby actually hindering proper development.

4) On the rare occurrences when Coaches find time to work individually with an Athlete and properly monitor and capture results when working together, when the Athlete is practicing on their own between coaching sessions, or working with someone else like another coach or even a parent, training can be inconsistent with what was taught originally by the primary Coach.

5) And perhaps most importantly, while there are often concerted efforts to plan team activities such as games and structured team practice time, Athletes are often left on their own to plan, execute and track their individual training, which in most cases can have the greatest impact, both positive and negative, to their development. Sadly, this individual training can become either a low priority, or go completely ignored if the Athlete does not get the proper direction and motivation.

In conclusion, having a single system and process to properly direct and track all training activity would potentially reap significant benefits to Athlete development, not to mention the additional benefit of maximizing Coaches time and effort.

### SUMMARY OF THE INVENTION

The training system is designed to formally manage, enhance and automate the currently fragmented and incomplete workflow, delivery and tracking of sports training and development. More simply stated it provides a formalized platform for assessing, training, capturing and directing skills that are crucial to advancing the development of the Athlete, that are needed to succeed and excel in a variety of sports.

The system is extremely comprehensive as it encompasses:

Focused single skill and integrated multiple skill development; Can be used in a training facility equipped with the system, or remotely anywhere an Internet connection and compatible device is available;

Gives Athletes the guidance to work independently or under the direction of a live coach;

Drives Athlete's efforts using a best of breed curriculum, created by industry experts, administered at the level and pace appropriate for each individual Athlete; and

Encompasses all aspects of training activity ranging from formal lessons and organized games, to self-initiated and monitored drills and exercises.

In addition, the system addresses another major concern in the sports industry—Athlete health. By guiding and capturing all of the Athlete's activity, the system ensures that the Athlete is not overworked, uses proper mechanics to accomplish tasks and pays attention to healthy training practices to aid in avoiding injuries.

Furthermore, the system collects and provides benchmarking information to compare individual results against a pool of others. It also, based on the Athlete's area of focus results and interests serves up personalized content, products and services, and supplementary training programs for proper nutrition and mental acuity.

And finally, the system provides the ability to share your training sessions and results with others, either real time through the use of secure streaming video and chat interfaces, or by distributing the training session results via email, text, or posting on social media to friends, family, peers, coaches, or anyone else the Athlete chooses.

Although transparent to the Athlete, in the background, the system contains a powerful set of management tools that allows administrators to easily update Athlete records, training content and curriculum as needed. It also guides all scheduling, accounting and billing functions related to the training process. By handling these tasks, Coaches that use the system can concentrate on Athlete development rather than time consuming administrative tasks.

In a nutshell, the automated workflow system guides all activity, captures and analyzes the results, and provides direction for development areas—in effect, it provides everything you need to build a better performing, more focused athlete.

### BRIEF DESCRIPTION OF THE DRAWINGS

The accompanying drawings are provided to give additional clarity to the workflow, structure and applications of the automated sports training workflow, delivery and tracking system:

FIG. 1 is a flow chart outlining each major step and the automated workflow of the training system.

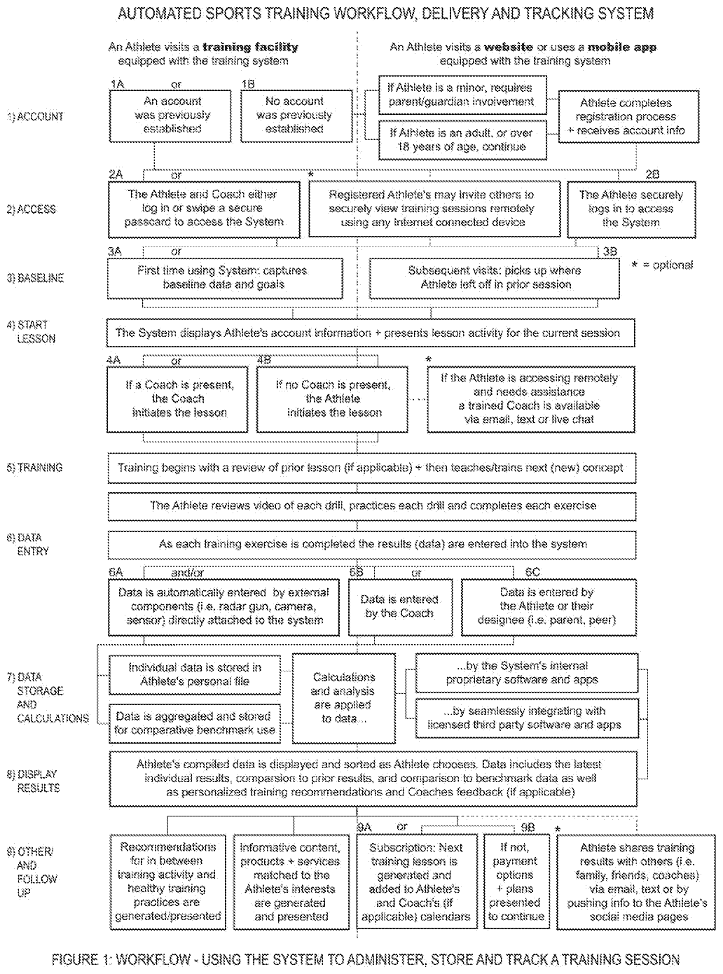

FIG. 2 shows the system in use in the Company's batting cages on a tablet computer to facilitate a training session. The administrator of the lesson is using the optional pass card security feature to access confidential information, access curriculum and initiate training session.

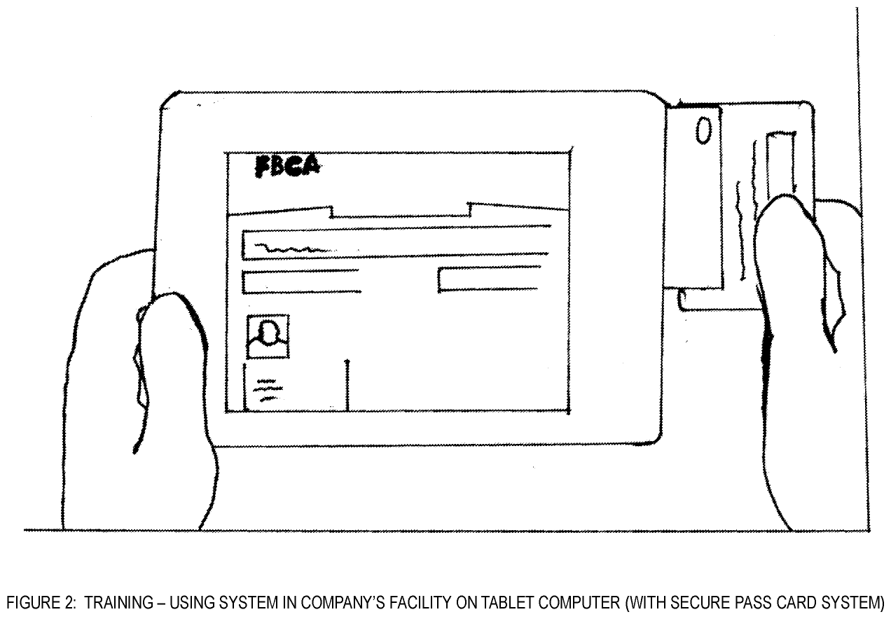

FIG. 3 shows trained Coaches using the system at the Company's facility on i) a kiosk, and ii) on a personal computer to guide and track training sessions.

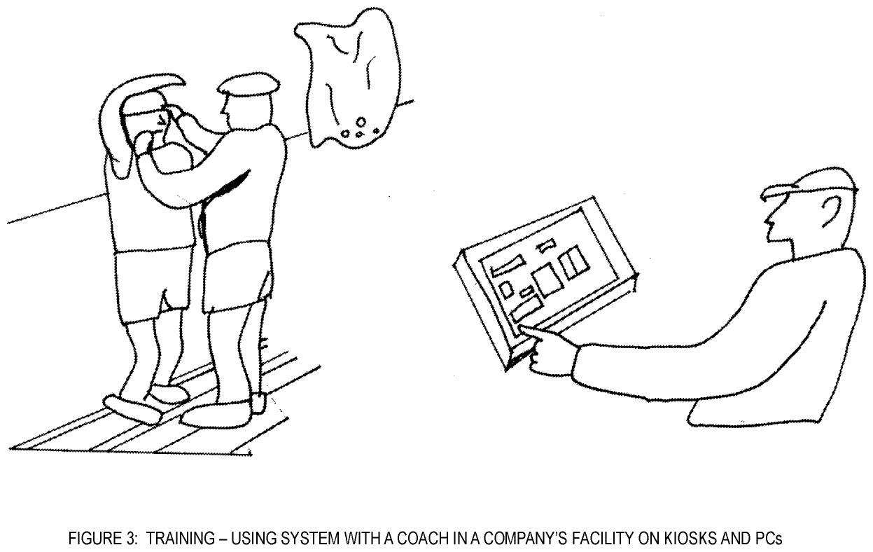

FIG. 4 shows the use of the system at the Company's facility in conjunction with integrated third-party hardware and licensed software (radar gun and swing analyzer).

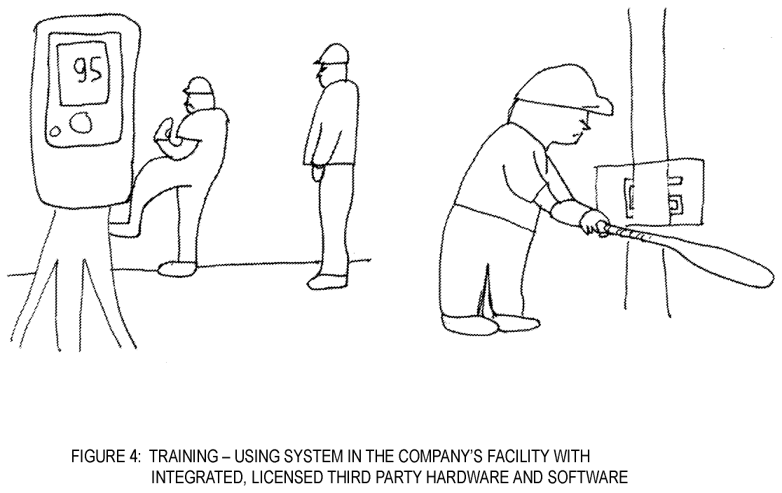

FIG. 5 shows the system being used outside the Company's facility for independent use by an Athlete.

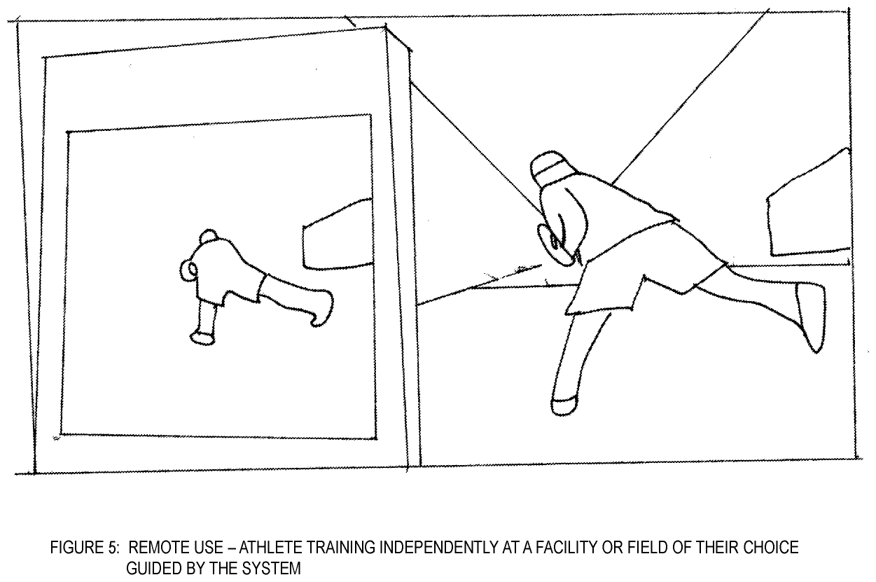

FIG. 6 shows a lesson, guided by the system, being viewed remotely in both the Company's facility in their on-site restaurant, or through the use of any connected device and a secure log in from anywhere around the world.

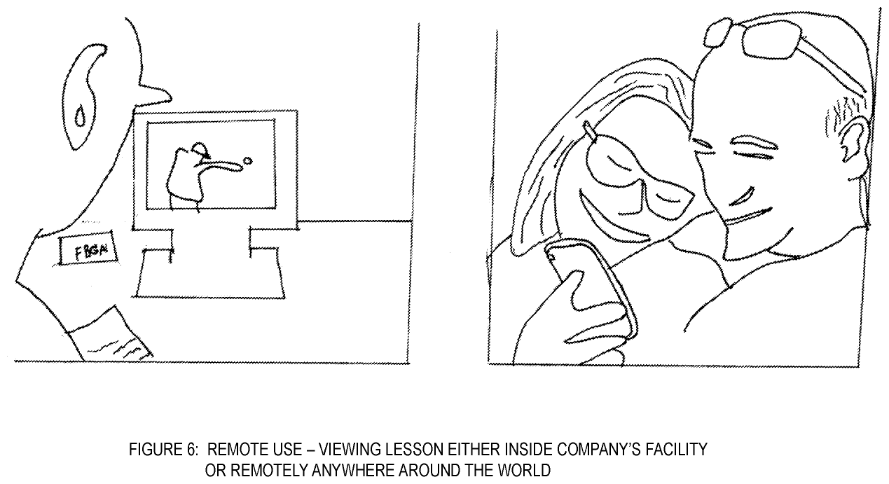

FIG. 7 shows a “Team Parent” using the system to view results, coordinate schedule changes, send individual or group messages, or pay for training and equipment.

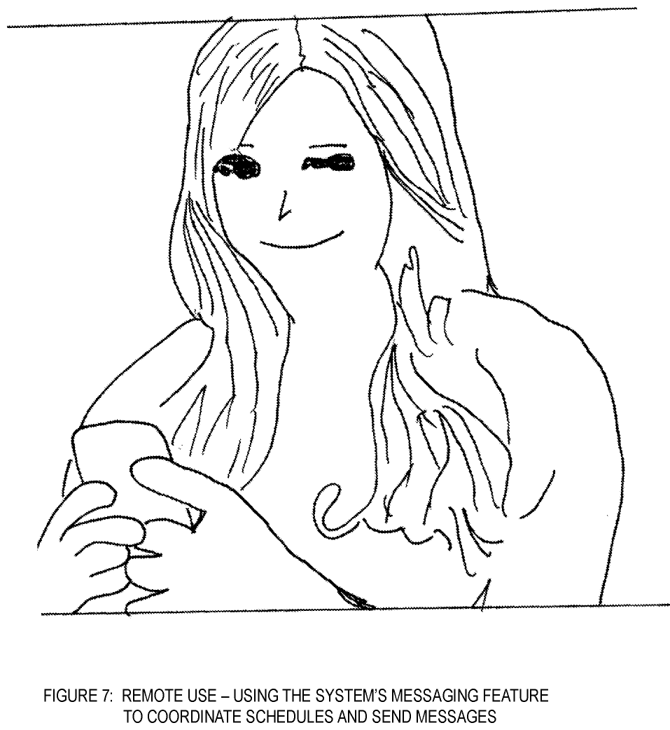

FIG. 8 shows Athletes using the system to guide in between lesson workout activity.

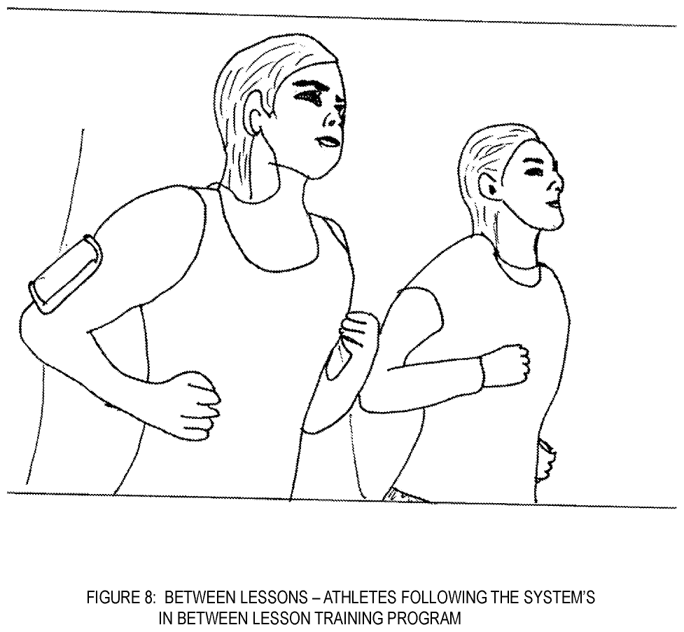

FIG. 9 shows Athletes uploading their workout and practice data to the system remotely both manually by entering data into a tablet, laptop or desktop computer and using their mobile phone to capture photos and videos.

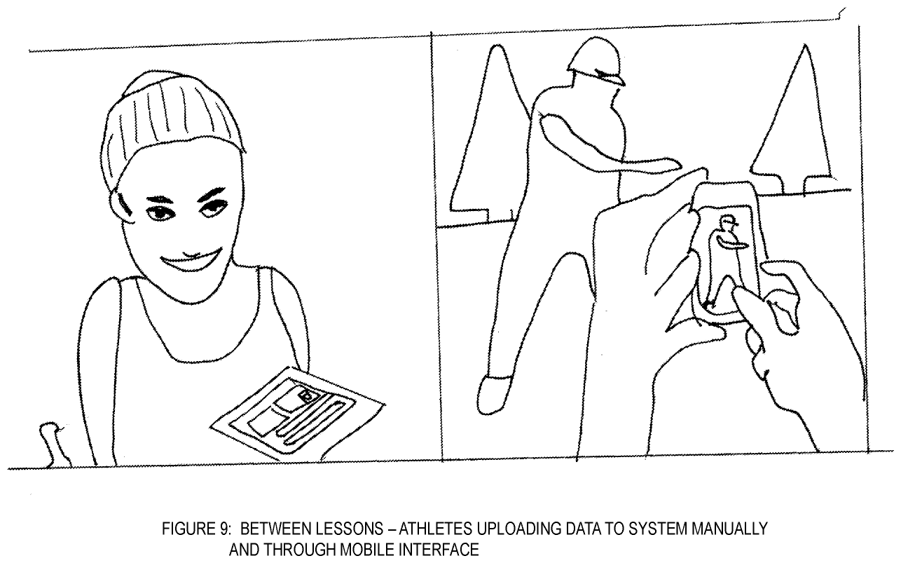

FIG. 10 shows a young Athlete and his parent using the system to learn, track training progress and shop online for equipment specified by their team or Coach.

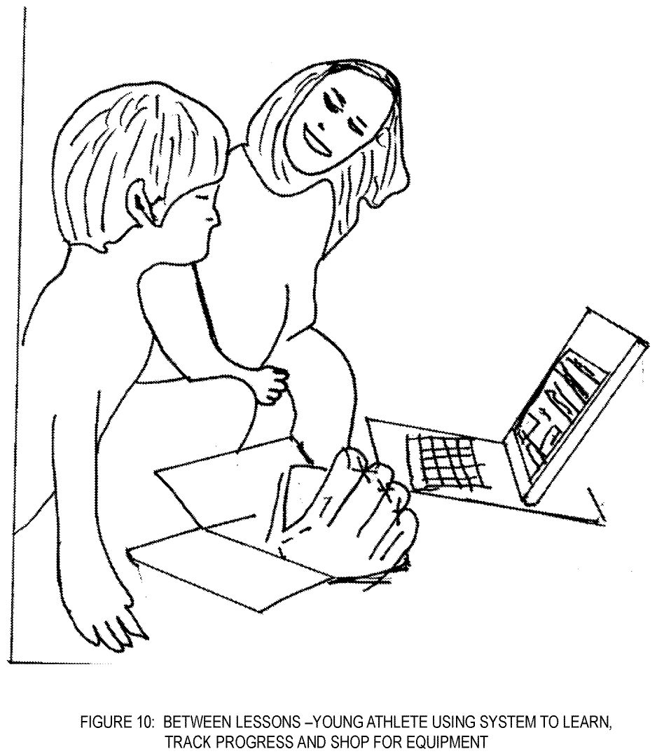

### DETAILED DESCRIPTION

The automated sports training workflow, delivery and tracking system has been created for use in a variety of sports, for numerous competencies and for any skill level that can benefit from highly focused, guided and tracked, automated individual Athlete training.

The system aggregates all of the unique activity that takes place (lessons, workout sessions, games, practices, et cetera) that contributes to Athlete skill development and training, into one place. It guides training activities using a standardized curriculum focused on teaching specific skills, delivers the curriculum at a pace and level in accordance with each individual athlete, and gathers the statistics and data from all training activity. The system then analyzes all of the activity, compares it to prior performance and peer benchmarks, and creates a plan for directing the Athlete's future development to attain a higher level of performance compared to conventional, fragmented training techniques.

Athletes can use the system by visiting a physical training facility in which the system is deployed and, with the guidance of a Coach, work through the exercises, capture the results and receive direction and feedback for future development activity. They can also access the system remotely using any electronic device that connects to the Internet and uses a web browser. When working remotely, the Athlete can choose to work independently, work with their own local Coach, or communicate with the “Live Coach” application that is built into the system and uses electronic email, text and chat technologies to communicate.

Due to the varied nature of tasks managed by the system, it is comprised of a combination of proprietary software applications housed within an open architecture. This open architecture allows the integration of additional licensed third-party software and applications as needed, to accomplish more specialized tasks that are not built into the system.

Initially, to access and use the system, the Athlete must register and pay any required fees using one of the payment methods provided. When first logging into the system, the Athlete is presented with their personal account information, their results to date, and an invitation to begin their training session. They can also enter results from outside activity, read related personalized content, manage their account and profile settings, shop for products and services of interest and share their results with others. If it is their first time accessing the system, they will be guided through a series of exercises designed to collect a baseline of information, which can later be compared to information collected in future training sessions. The Athlete will also be guided through a process to capture their personal training goals.

When using a facility to initiate a training session, a Coach will guide the Athlete through the process of reviewing their prior lesson and then continue on to the new drills, exercises and activities delivered by the system for their current lesson. The resulting data generated from the training session includes the necessary input to calculate a series of key metrics for tracking Athlete performance. These metrics include both ‘industry-standard’ statistics for the specific sport or competency, as well as a number of new criteria, unique to the system, that drive more focused and meaningful assessment of the Athlete's skills, deficiencies, and development areas. This data can be entered by the Coach manually as the system prompts him to do so or directly through the use of a number of devices integrated into the system to help automate the process.

Once the data is collected, it is stored for archival and benchmarking purposes. The data is presented to the Athlete showing a comparison to prior training results, overall progress, and a comparison to other similar Athletes. The Athlete can choose to manipulate and sort the data in a variety of predetermined formats to meet their needs and preferences. In essence, this information forms a ‘dashboard’ of crucial feedback for the Athlete, their Coach(es) and anyone else the Athlete chooses to share the information with.

Completing the lesson and analyzing the feedback triggers the system to present the Athlete and Coach with specific instructions and guidance for subsequent training activity. These recommendations include those that are Coach taught as well as independent training that occurs in between formal lessons by the Athlete. The independent training is accessed by the Athlete using an Internet connected device and a web browser from the location of their choice. The Athlete can log into the system remotely using a mobile phone, tablet computer, laptop or desktop PC and view drills and exercises, read content about rules and strategy, follow nutrition plans, enter independent training results, et cetera. They are also presented with customized reading material, products and services that the system matches to their interests and, in some cases, also receive advertising that matches their demographics and interests as well.

By having a system in place that clearly communicates goals, activities and objectives, demonstrates how drills and exercises are done, and tracks independent work, Athletes are much more motivated to complete the assigned tasks. If an Athlete adheres to the training program, they will receive a far more complete, comprehensive and targeted experience, directed to specific development needs, thereby progressing their skills faster and more effectively than through other types of training.

When unable to visit a facility, the Athlete can still access the majority of the system's training functionality on their own remotely and attain similar results.

The system also allows the Athlete to add other important personal information such as academic performance, key accomplishments and pertinent experiences that are not tracked by the system, to their records in the system. Then the system provides the Athlete with the functionality to communicate and share this information, combined with their training results, with others via email, text or through social media. The Athlete can also choose to send the information to schools, recruiters or agents that might be interested in the Athlete.

In an embodiment 1, the automated sports training workflow, delivery and tracking system is comprised of a series of integrated proprietary and licensed third-party software programs and applications that when combined use this integrated technology to guide, deliver, enhance and track Athlete training and skill development. The system accomplishes this by teaching and tracking progress of key competencies and skills critical to becoming proficient in a specific sport.

In an embodiment 2, the system in embodiment 1 is compatible with a variety of electronic platforms and delivery devices. Compatible electronic platforms include Mac and PC (computer) as well as Android and Apple (mobile). Compatible devices include mobile phones, tablet computers, laptop computers, desktop computers and any other device that 1) has a connection to the internet and cloud, and 2) operates a web browser.

In an embodiment 3, the system in embodiment 1 can be used locally inside a training facility or anywhere else the Internet and a web browser is accessible using a mobile, wireless/Wi-Fi, or local area network connection.

In an embodiment 4, the system in embodiment 1 can be used by the Athlete independently, or with the assistance of an experienced Coach, Trainer, Parent or Other Designee. When used independently, a “Live Coach” interface is available allowing the Athlete to electronically text, voice or video chat with an experienced Coach about their training. If the Athlete is a minor, the system is designed to require parent or guardian involvement to set up an account, access and use.

In an embodiment 5, the system in embodiment 1 utilizes a standardized curriculum, created by industry experts from all aspects and levels of a given sport, to deliver a consistent experience based on best of breed practices and proven results. The curriculum uses a building block approach to training, teaching core skills, reviewing skills, and then introducing new skills. The curriculum encompasses all phases of training activity including planning, warm up, lessons, recovery and between lesson activities; The curriculum is defined and delivered based on the Athlete's chosen sport and area of concentration, amount of Athlete playing experience, level of achievement, and pace of learning.

In an embodiment 6, athletes can use the system in embodiment 1 to improve a single competency or skill, or multiple competencies or skills within a given sport. When addressing more than one competency, the system tracks and integrates all activities into one central repository, coordinating the training activity and eliminating the need to enter redundant information.

In an embodiment 7, as the curriculum in embodiment 5 is administered, key data points are captured in the system's various databases, both manually by an Instructor (i.e., Coach), as well as automatically by the system through interfacing with other third-party applications and equipment. This third-party equipment, for example, could include radar guns to track speed, cameras to take still photos or videos, sensors to track location, et cetera. The system's open interface communicates with third party applications to assist in specialized tasks and calculations related to the training. This third-party software, for example, could include batting swing analysis software, pitching analysis software, et cetera.

In an embodiment 8, the system in embodiment 1 is accessible from anywhere, using a unique username and password stored in the system. Security and privacy applications are also integrated to accommodate background checks of anyone who is working with the Athlete (i.e. Coaches or Trainers) and a pass card system for secure access to the system.

In an embodiment 9, when first using the system in embodiment 1, an initial set of data, as well as the Athlete's personal goals and milestones, are collected to provide a baseline, or starting point, for the Athlete.

In an embodiment 10, the majority of the data gathered during training sessions in embodiment 7 is used by the system to calculate and track the Athlete's progress using both standard, industry accepted statistics, as well as newly created, and in some cases far more meaningful, information available through the system.

In an embodiment 11, the information gathered from the training sessions in embodiment 7 is stored on both the Company's secure servers as well as the Internet Cloud using the latest encryption and security applications.

In an embodiment 12, all of the system calculations in embodiment 7 are analyzed and combined to drive a specific set of recommendations to better aid the Athlete in developing key skills needed for success in their sport.

In an embodiment 13, all information in embodiment 7 is tracked over time, archived and can be sorted and displayed in a variety of formats.

In an embodiment 14, the system continuously and automatically collects and aggregates the individual Athlete data from embodiment 7 into larger pools of information, useful for benchmarking and comparing the Athlete's performance to that of a group of their peers.

In an embodiment 15, Athletes or Coaches can also enter data into the system in embodiment 1 from other related activities that are outside of training sessions (such as games, practices, other lessons, et cetera) but meaningful to the Athlete's workload and development, providing them a more complete and cohesive view of the Athlete's efforts.

In an embodiment 16, the combined data from embodiments 7 and 15 is useful to ensure the Athlete is not being overworked or put in a situation where their health can be compromised. A healthy training guide, as well as an agreement between the Athlete and any Coaches that use the system addressing safe and healthy training practices, is included as well.

In an embodiment 17, the system in embodiment 1 includes a feedback component whereby a Coach, Trainer, Parent or other Administrator can enter additional comments and feedback for the Athlete, as well as providing the Athlete an opportunity to provide similar comments and feedback back to their Coach(es) or others using the system.

In an embodiment 18, the system hi embodiment 1 helps to synchronize activity and communications if multiple Coaches are engaged by the Athletes during their training.

In an embodiment 19, the system in embodiment 1 coordinates training and lesson schedules as well as other administrative tasks such as accounting and payment for services.

In an embodiment 20, the system in embodiment 1 is tied into a variety of popular payment gateways and services to facilitate any payments, refunds or financial related account adjustments.

In an embodiment 21, the system in embodiment 1 includes an administrative control panel allowing easy updating and editing of all content, training curriculum, Athlete and Coach information, by an Administrator.

In an embodiment 22, the system in embodiment 1 has built-in alerts, reminders and messages that can be sent to a designated contact or contact list regarding changes to training schedules, account status, or other general communications.

In an embodiment 23, the information presented in embodiment 14 can also be shared (pushed) to the Athlete's or Coach's social media pages on Facebook, Twitter, LinkedIn or virtually any other social media platform, for others such as family, friends, coach's et cetera to view and comment, based on the Athlete's predetermined sharing preferences. Other contacts of the Athlete may also be invited via text or email messages to view the information as well.

In an embodiment 24, if the Athlete is in a facility equipped with the system in embodiment 1, invitations can be sent to allow remote viewing of training sessions to anyone the athlete designates. Remote sessions can be viewed using any device that uses a web browser and the system's secure interface. Remote viewers can send messages of encouragement provide feedback and send funds electronically to either pay for the training session or for the Athlete to spend in the facility or on the Company's website.

In an embodiment 25, the system in embodiment 1 can be used in between formal training sessions to coordinate and administer the Athlete's independent activities such as working out, drills and exercises, a nutrition plan, mental acuity training and other content that contribute to the development and training of the Athlete.

In an embodiment 26, the system in embodiment 1 delivers personalized content to the Athlete, based on their interests, including related news, educational information, resources, proper health and training practices, recommended reading, et cetera.

In an embodiment 27, the system in embodiment 1 also delivers advertising for and links to direct sales of products and services that would be of interest to the Athlete based on their activity, preferences and demographics.

In an embodiment 28, the system in embodiment 1 allows the Athlete to add additional personal information such as academic performance, other training or programs that have been completed, certifications, awards and accomplishments, et cetera.

In an embodiment 29, the system in embodiment 1 can be used to coordinate and keep the Athlete's schedule, save favorites, keep notes, create wish lists, upload and store photos and videos, et cetera.

In an embodiment 30, Athlete-generated content from embodiments 28 and 29, combined with other system generated statistics from embodiments 7 and 15, can be used to create a personal resume that may be sent by the system to programs, schools, colleges, and recruiters upon the Athlete's request.

What is claimed is:

1. An automated training workflow, delivery and tracking system comprising:
a computer device configured to elicit and collect athletic-skill data regarding athletic skills of a first subject athlete including statistics and criteria for a specific competency of the first subject athlete;
a database operatively coupled to the computer device and configured to store the collected data regarding athletic skills of the first subject athlete for archival and benchmarking purposes;
a comparison application operatively coupled to the computer device and configured to compare the collected data regarding athletic skills of the first subject athlete to prior results associated with the first subject athlete and to other data from similar subject athletes to obtain comparison results;
a plan application operatively coupled to the computer device and configured to perform an analysis on the collected data regarding athletic skills of the first subject athlete and the comparison results, and to generate specific instructions and guidance for subsequent training of the first subject athlete based on the analysis; and
a display operatively coupled to the computer device and configured to:
present the collected data regarding athletic skills of the first subject athlete and comparison results to the first subject athlete, and
present the specific instructions and guidance for subsequent training to the first subject athlete.

2. The system of claim 1, wherein the database is on an encrypted server.

3. The system of claim 1, wherein the computer device is one of a plurality of devices, each associated with the first subject athlete, and each integrated into the system to help automate a process performed by the system.

4. The system of claim 1, wherein the display presents the collected data regarding athletic skills of the first subject athlete and comparison results as a dashboard of feedback in one of a plurality of predetermined formats.

5. The system of claim 1, wherein the system is further configured to match interests of the first subject athlete to customized reading material, products and services and present to the first subject athlete the customized reading material, products and services.

6. The system of claim 1, wherein the computer device is configured to provide communications functionality to the first subject athlete via email.

7. The system of claim 1, wherein the computer device is configured to continuously and automatically collect and aggregate the data regarding athletic skills of the first subject athlete into larger pools of information that is used to benchmark and compare a performance of the first subject athlete to that of a group of peers of the first subject athlete.

8. The system of claim 1, wherein the database is on a cloud-based server.

9. The system of claim 1, wherein the computer device includes a mobile device.

10. An automated training workflow, delivery and tracking method comprising:
eliciting and collecting, into a computer device, data regarding athletic skills of a first subject athlete including statistics and criteria for a specific competency of a subject;
storing, into a database operatively coupled to the computer, the collected data regarding athletic skills of the first subject athlete for archival and benchmarking purposes;
comparing, using a comparison application operatively coupled to the computer, the collected data regarding athletic skills of the first subject athlete to prior results associated with the first subject athlete and to other data from similar subject athletes to obtain comparison results;
analyzing, using a plan application operatively coupled to the computer, the collected data regarding athletic skills of the first subject athlete and the comparison results, and generating, using the plan application, specific instructions and guidance for subsequent training of the first subject athlete based on the analyzing;
presenting to the first subject athlete, using a display operatively coupled to the computer device, the collected data regarding athletic skills of the first subject athlete and comparison results; and
presenting to the first subject athlete, using the display operatively coupled to the computer device, the specific instructions and guidance for the subsequent training.

11. The method of claim 10, wherein the database is on an encrypted server.

12. The method of claim 10, wherein the computer device is one of a plurality of devices, each associated with the first subject athlete, and each integrated into the system to help automate a process performed by the system.

13. The method of claim 10, wherein the presenting of the collected data regarding athletic skills of the first subject athlete and comparison results includes displaying a dashboard of feedback in one of a plurality of predetermined formats.

14. The method of claim 10, further comprising:
matching, using a match application operatively coupled to the computer device, interests of the first subject athlete to customized reading material, products and services; and
presenting to the first subject athlete, using the display operatively coupled to the computer device, the customized reading material, products and services.

15. The method of claim 10, further comprising:
continuously and automatically collecting and aggregating the data regarding athletic skills of the first subject athlete into larger pools of information; and
benchmarking and comparing a performance of the first subject athlete to that of a group of peers of the first subject athlete based on the larger pools of information.
